(19) United States
(12) Patent Application Publication
(10) Pub. No.: US 2023/0419179 A1
(43) Pub. Date: Dec. 28, 2023

(54) DEVICE FOR A ROBUST CLASSIFICATION AND REGRESSION OF TIME SERIES

(71) Applicant: Robert Bosch GmbH, Stuttgart (DE)

(72) Inventors: Frank Schmidt, Leonberg (DE); Joerg Schmitt, Ludwigsburg (DE); Julian Raible, Schömberg (DE); Marvin Frisch, Gaertringen (DE); Patrick Menold, Stuttgart (DE)

(21) Appl. No.: 18/252,031

(22) PCT Filed: Dec. 9, 2021
(86) PCT No.: PCT/EP2021/084995

§ 371 Date: May 5, 2023

(30) Foreign Application Priority Data
Dec. 21, 2020 (DE) 20 2020 107 432.6

(51) Int. Cl. G06N 20/00

(52) U.S. Cl. CPC G06N 20/00

(57) ABSTRACT

A computer-implemented machine learning system configured to ascertain an output signal based on a time series of input signals of a technical system. The output signal characterizes a classification and/or a regression result of at least one first operating state and/or at least one first operating variable of the technical system. The training of the machine learning system includes: ascertaining a first training time series of input signals from a plurality of training time series and a desired training output signal which corresponds to the first training time series; ascertaining a worst possible training time series which characterizes an overlap of the first training time series with an ascertained first noise signal; ascertaining a training output signal based on the worst possible training time series using the machine learning system; and adapting at least one parameter of the machine learning system according to a gradient of a loss value.

### FIELD

The present invention relates to a computer-implemented machine learning system, a training device for training the machine learning system, a computer program, and a machine-readable storage medium.

### BACKGROUND INFORMATION

European Patent Application No. EP 19 17 4931.6 describes a method for robustly training a machine learning system with respect to adversarial examples.

### BACKGROUND INFORMATION

Recordings of sensors are typically subject to more or less strong noise that is reflected in the sensor signals ascertained by the sensors. In an automatic processing of such sensor signals using a machine learning system, this noise is a typical source of interference that can significantly degrade a predictive accuracy of the machine learning system. In particular in a processing of time series of sensor signals, noise can have a severely negative impact on the predictive accuracy.

It is therefore desirable to train a machine learning system for processing time series such that the machine learning system becomes robust to noise. An advantage of the machine learning system with features according to present invention is that the machine learning system becomes more robust to noise as a result of its construction. Surprisingly, the inventors have found that methods of adversarial training can also be used to train the machine learning system such that it becomes robust to noise.

### SUMMARY

In a first aspect, the present invention relates to a computer-implemented machine learning system (60), wherein the machine learning system is configured to ascertain an output signal on the basis of a time series of input signals of a technical system, said output signal characterizing a classification and/or a regression result of at least one first operating state and/or at least one first operating variable of the technical system. According to an example embodiment of the present invention, a training of the machine learning system comprising the following steps:
a. ascertaining a first training time series of input signals from a plurality of training time series and a desired training output signal which corresponds to the first training time series, said desired training output signal characterizing a desired classification and/or a desired regression result of the first training time series;
b. ascertaining the worst possible training time series, said worst possible training time series characterizing an overlap of the first training time series with an ascertained first noise signal;
c. ascertaining a training output signal on the basis of the worst possible training time series using the machine learning system; and
d. adapting at least one parameter of the machine learning system according to a gradient of a loss value, said loss value characterizing a deviation of the desired training output signal from the ascertained training output signal.

Preferably, according to an example embodiment of the present invention, the input signals of the time series can each characterize a second operating state and/or a second operating variable of the technical system at a predefined time point. An input signal can in particular be recorded by means of a sensor, in particular a sensor of the technical system. In particular, the first operating state or the first operating variable can characterize a temperature and/or a pressure and/or a voltage and/or a force and/or a speed and/or a rotation rate and/or a torque of the technical system.

The machine learning system can therefore also be understood as a virtual sensor by means of which a first operating state or a first operating variable can be derived from a plurality of second operating states or second operating variables.

The training of the machine learning system can be understood as a supervised training. According to an example embodiment of the present invention, the first training time series used for the training may preferably comprise input signals that respectively characterize a second operating state and/or a second operating variable of the technical system or of a structurally identical technical system or of a structurally similar technical system or a simulation of the second operating state and/or of the second operating variable at a predefined time point. In other words, training time series of the plurality of training time series can be based on input signals of the technical system itself. Alternatively or additionally, it is possible that the training time series input signals are recorded by a similar technical system, wherein a similar technical system may, for example, be a prototype or an advance development of the technical system. It is also possible for the input signals of the training time series to be ascertained from another technical system, e.g., from another technical system of the same production line or production series. It is also possible that the input signals of the training time series are ascertained on the basis of a simulation of the technical system.

Typically, according to an example embodiment of the present invention, the input signals of the first training time series are similar to the input signals of the time series; in particular, the input signals of the training time series should characterize the same second operating variable as the input signals of the time series.

For training, the training time series can in particular be provided from a database, wherein the database comprises the plurality of training time series. The machine learning system may preferably iteratively perform the steps a. to d.

Preferably, a plurality of training time series may also be used in each iteration to ascertain the loss value, i.e., the training may also be carried out with a batch of training time series.

According to an example embodiment of the present invention, the output signals can comprise a classification and/or a regression result. A result of regression is to be understood as a regression result. The machine learning system can therefore be considered as a classifier and/or regressor. The term “regressor” can be understood to mean a device that predicts at least one real value with respect to at least one real value.

The time series and the training time series are each preferably provided as a column vector, wherein one dimension of the vector respectively characterizes a measured value at a particular time point within the time series or the training time series.

The worst possible training time series can be understood as a training time series that is produced when the first training time series is overlapped with a noise signal such that a distance of a training output of the machine learning system for the thus overlapped training time series from the training output ascertained for the first training time series becomes as large as possible. In particular, the noise can still be limited with respect to suitable boundary conditions so that the worst possible training time series is not a trivial result of the overlap. In the described invention, the noise signal is in particular limited such that it corresponds to an expected noise signal. The expected noise signal can in particular be understood on the basis of the plurality of training time series. In this sense, the method can be understood as a form of adversarial training, wherein the adversarial training is advantageously limited to a noise characteristic of the training time series. The inventors have found that the adversarial training thus also surprisingly and advantageously results in a machine learning system that is more robust to noise.

According to an example embodiment of the present invention, preferably, in step b., the first noise signal can be ascertained by optimization such that a distance of a second output signal from the desired output signal is enlarged, wherein the second output signal is ascertained by the machine learning system on the basis of an overlap of the first training time series with the first noise signal.

The noise signal can in particular be provided in the form of a vector, wherein the vector has the same dimensionality as the vector form of the first training time series. The overlap can then, for example, be a sum of the vector of the first training time series and the vector of the noise signal. Here, a mathematical optimization under boundary conditions can be understood as an optimization. In particular, an expected noise signal can be introduced as boundary conditions in the method.

According to an example embodiment of the present invention, in a preferred design of the machine learning system, the first noise signal can therefore be ascertained in step b. on the basis of an expected noise value of the plurality of training time series, wherein the expected noise value characterizes an average intensity of noise of the training time series.

In particular, the expected noise value can be an average distance of a training time series of the plurality of training time series from a respective denoised training time series.

According to an example embodiment of the present invention, in a preferred design of the machine learning system, the expected noise value can be ascertained according to the formula

$$Δ = \frac{1}{n} {\sum }_{i = 1}^{n} {‖ {x}_{i} - {z}_{i} ‖}_{2} ,$$

wherein n is the number of training time series of the plurality of training time series, zᵢ is the denoised training time series for the training time series xᵢ, and ∥⋅∥₂ is a Euclidean norm.

This can be understood such that a training time series is first denoised and a distance of the training time series from the denoised training time series is subsequently ascertained. The average distance across all or at least portions of the plurality of training time series can then be understood as the expected noise. The expected noise can therefore be understood as a scalar value.

Preferably, the denoised training time series can be ascertained according to the formula

zᵢ=Cₖ⁺·xᵢ,

wherein Cₖ⁺ is a pseudo-inverse covariance matrix.

Here, according to an example embodiment of the present invention, the pseudo-inverse covariance matrix can be ascertained by the following steps:
e. ascertaining a second covariance matrix, wherein the second covariance matrix is the covariance matrix of the plurality of training time series (xᵢ);
f. ascertaining a predefined plurality of greatest eigenvalues of the second covariance matrix as well as eigenvectors corresponding to the eigenvalues;
g. ascertaining the pseudo-inverse covariance matrix according to the formula

$${C}_{k}^{+} = {\sum }_{i = 1}^{k} \frac{1}{{λ}_{i}} \cdot {v}_{i} {v}_{i}^{T} ,$$

wherein λᵢ is the i-th eigenvalue of the plurality of greatest eigenvalues, and k is the number of greatest eigenvalues in the predefined plurality of greatest eigenvalues.

The pseudo-inverse covariance matrix can be understood as part of a noise model. By means of the pseudo-inverse covariance matrix, the first training time series xᵢ can be denoised as described above and the denoised training time series zᵢ can thus be ascertained. A distance of the first training time series from the denoised training time series can then be understood as a noise value of the first training time series.

The plurality of greatest eigenvalues therefore comprises a predefined number of eigenvalues, wherein only the greatest eigenvalues of the covariance matrix are contained in the plurality of eigenvalues.

The eigenvectors can be understood as column vectors in this case.

According to an example embodiment of the present invention, in a preferred design of the machine learning system, the first noise signal can be ascertained on the basis of a provided adversarial perturbation, wherein the provided adversarial perturbation is limited according to the expected noise value.

An adversarial perturbation can be understood to be a perturbation by means of which an adversarial example is generated when a corresponding training time series is overlapped with the adversarial perturbation.

According to an example embodiment of the present invention, in a preferred design of the machine learning system, the adversarial perturbation is limited such that a noise value of the adversarial perturbation is not greater than the expected noise value. Preferably, the adversarial perturbation can be provided according to the following steps:
h. providing a first adversarial perturbation;
i. ascertaining a second adversarial perturbation, wherein the second adversarial perturbation is stronger than the first adversarial perturbation;
j. providing the second adversarial perturbation as the adversarial perturbation if a distance of the second adversarial perturbation from the first adversarial perturbation is less than or equal to a predefined threshold;
k. otherwise, if the noise value of the second adversarial perturbation is less than or equal to an expected noise value, performing step i., wherein, in the performance of step i., the second adversarial perturbation is used as the first adversarial perturbation;
l. otherwise, ascertaining a projected perturbation and performing step j., wherein, in the performance of step j., the projected perturbation is used as the second adversarial perturbation, and wherein the projected perturbation is ascertained by an optimization such that a distance of the projected perturbation from the second adversarial perturbation is as small as possible and the noise value of the projected perturbation is equal to the expected noise value.

According to an example embodiment of the present invention, a first adversarial perturbation may be ascertained randomly or may contain at least one predefined value. Since an adversarial perturbation is preferably provided in the form of a vector, the first adversarial perturbation in step h. may, for example, be a zero vector or a random vector.

According to an example embodiment of the present invention, a second adversarial perturbation can be understood to be stronger than a first adversarial perturbation if a second training output signal ascertained with respect to a training time series overlapped with the second adversarial perturbation has a greater distance from the desired training output signal of the training time series than a first training output signal ascertained with respect to a training time series overlapped with the first adversarial perturbation does.

A noise value of an adversarial perturbation can be ascertained according to the formula

r((δ,Cₖ⁺)=∥δ−Cₖ⁺·δ∥²,

wherein δ is the adversarial perturbation.

Preferably, in step i., the second adversarial perturbation can be ascertained according to the formula

δ₂=δ₁+α·Cₖ·g,

wherein δ₁ is the first adversarial perturbation, α is a predefined step-width value, Cₖ is a first covariance matrix, and g is a gradient.

This characteristic can be understood as an adaptation of a projected gradient descent method, wherein the gradient is adapted according to the noise model. The inventors have found that this results in the ascertained noise signal being substantially closer to real-world noise signals than to noise signals ascertained by means of normal projected gradient descent. The improved noise signal can make the machine learning system significantly more robust to expected noise.

According to an example embodiment of the present invention, the gradient g can be ascertained according to the formula

g=∇ₓ_{ᵢ}[L(f(xᵢ+δ₁),tᵢ)],

wherein L is a loss function, tᵢ is the desired training output signal with respect to the training time series, and f(xᵢ+δ₁) is the result of the machine learning system if the training time series overlapped with the first adversarial perturbation δ₁ is passed to the machine learning system.

The first covariance matrix can be ascertained according to the formula

$${C}_{k} = {\sum }_{i = 1}^{k} {λ}_{i} \cdot {v}_{i} {v}_{i}^{T} .$$

The projected adversarial perturbation can be ascertained according to the formula

$${δ}_{p} = {argmin}_{d , r ( d , {C}_{k}^{+} ) = Δ} {‖ d - {δ}_{2} ‖}_{2} .$$

It is furthermore possible that the output signal characterizes a regression of at least the first operating state and/or at least the first operating variable of the technical system, wherein the loss value characterizes a squared Euclidean distance between the ascertained training output and the desired training output.

In particular, according to an example embodiment of the present invention, the technical system can be an injection device of an internal combustion engine and the input signals of the time series each characterize at least one pressure value or an average pressure value of the injection device, e.g., a common rail diesel, and the output signal characterizes an injection amount of a fuel, wherein the input signals of the training time series each furthermore characterize at least one pressure value or an average pressure value of the internal combustion engine or of a structurally identical internal combustion engine or of a structurally similar internal combustion engine or of a simulation of the internal combustion engine, and the desired training output signal characterizes an injection amount of the fuel.

Alternatively, according to an example embodiment of the present invention, it is also possible that the technical system is a production machine, which produces at least one part, wherein the input signals of the time series each characterize a force and/or a torque of the production machine, and the output signal characterizes a classification as to whether or not the part was produced correctly, wherein the input signals of the training time series each furthermore characterize a force and/or a torque of the production machine or of a structurally identical production machine or of a structurally similar production machine or of a simulation of the production machine, and the desired training output signal is a classification as to whether a part was produced correctly.

In a further aspect, the present invention relates to a training device designed to train the machine learning system according to steps a. to d.

Embodiments of the present invention are explained in greater detail below with reference to the figures.

### BRIEF DESCRIPTION OF THE DRAWINGS

FIG. 1 schematically illustrates a training system for training a classifier, according to an example embodiment of the present invention.

FIG. 2 schematically illustrates a structure of a control system for controlling an actuator by means of the classifier, according to an example embodiment of the present invention.

FIG. 3 schematically illustrates an exemplary embodiment for controlling a production system, according to the present invention.

FIG. 4 schematically illustrates an exemplary embodiment for controlling an injection system, according to the present invention.

### DETAILED DESCRIPTION OF EXAMPLE EMBODIMENTS

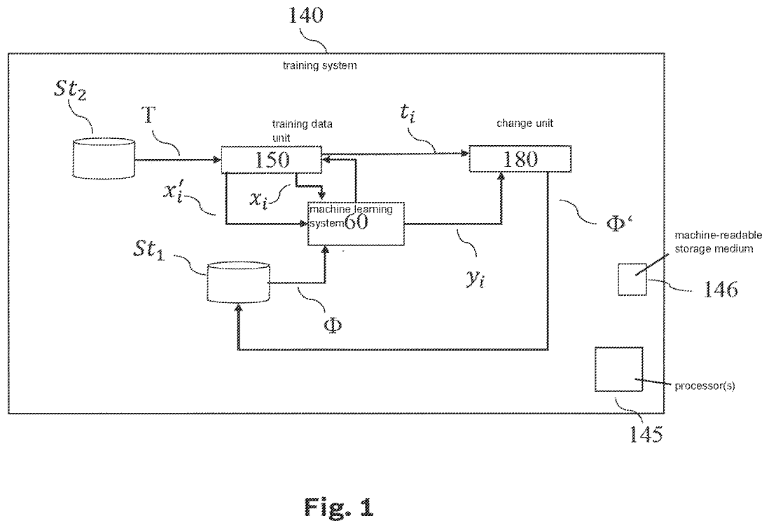

FIG. 1 shows an exemplary embodiment of a training system (140) for training a machine learning system (60) by means of a training data set (T). Preferably, the machine learning system (60) comprises a neural network. The training data set (T) comprises a plurality of training time series (xᵢ) of input signals of a sensor of a technical system, wherein the training time series (xᵢ) that are used to train the machine learning system (60), wherein the training data set (T) further comprises, for each training time series (xᵢ), a respective desired training output signal (tᵢ) which corresponds to the training time series (xᵢ) and characterizes a classification and/or a regression result with regard to the training time series (xᵢ). The training time series (xᵢ) are preferably provided in the form of a vector, wherein the dimensions respectively characterize time points of the training time series (xᵢ).

For the training, a training data unit (150) accesses a computer-implemented database (St₂), wherein the database (St₂) provides the training data set (T). The training data unit (150) first ascertains a first covariance matrix from the plurality of training time series (xᵢ). For this purpose, the training data unit (150) first ascertains the empirical covariance matrix of the training time series (xᵢ). Subsequently, the k greatest eigenvalues as well as the associated eigenvectors are ascertained and the first covariance matrix Cₖ is ascertained according to the formula

Cₖ=Σᵢ₌₁^{k}λᵢ·vᵢvᵢ^{T},

wherein λᵢ is one of the k greatest eigenvalues, vᵢ is the eigenvector associated with λᵢ in column form, and k is a predefined value. In addition, a pseudo-inverse covariance matrix Cₖ⁺ is ascertained according to the formula

$${C}_{k}^{+} = {\sum }_{i = 1}^{k} \frac{1}{{λ}_{i}} \cdot {v}_{i} {v}_{i}^{T} .$$

In addition, an expected noise value Δ is ascertained according to the formula

$$Δ = \frac{1}{n} {\sum }_{i = 1}^{n} {‖ {x}_{i} - {C}_{k}^{+} \cdot {x}_{i} ‖}_{2} ,$$

wherein n is the number of training time series (xᵢ) in the training data set (T).

From the training data set (T), the training data unit (150) subsequently ascertains, preferably randomly, at least one first training time series (xᵢ) and the desired training output signal (tᵢ) corresponding to the training time series (xᵢ). On the basis of the machine learning system (60), the training data unit (150) then ascertains a worst possible training time series (xl) according to the following step:
m. providing a first adversarial perturbation δ₁, wherein a null vector that has the same dimensionality as the first training time series (xᵢ) is selected as the first adversarial perturbation;
n. ascertaining a gradient g according to the formula

g=∇ₓ_{ᵢ}[L(f(xᵢ+δ₁),tᵢ)],

wherein f(xᵢ+δ₁) the output of the machine learning system (60) with respect to an overlap of the first training time series;
o. ascertaining a second adversarial perturbation according to the formula

δ₂=δ₁+α·Cₖ·g,

wherein α is a predefined step width;
p. providing the second adversarial perturbation as the adversarial perturbation δ if a Euclidean distance of the second adversarial perturbation from the first adversarial perturbation is less than or equal to a predefined threshold;
q. otherwise, if the noise value

r(δ,Cₖ⁺)=∥δ−Cₖ⁺·δ∥₂

of the second adversarial perturbation is less than or equal to an expected noise value Δ, performing step n., wherein, in the performance of step n., the second adversarial perturbation is used as the first adversarial perturbation;
r. otherwise, ascertaining a projected perturbation according to the formula

$${δ}_{p} = {argmin}_{d , r ( d , {C}_{k}^{+} ) = Δ} {‖ d - {δ}_{2} ‖}_{2}$$

and performing step p., wherein, in the performance of step p., the projected perturbation is used as the second adversarial perturbation.

On the basis of the adversarial perturbation provided, the worst possible training time series (x′ᵢ) is then according to the formula

x′ᵢ=xᵢ+δ

The worst possible training time series (x′ᵢ) is then transmitted to the machine learning system (60), and a training output signal (yᵢ) for the worst possible training time series (x′ᵢ) is ascertained by the machine learning system.

The desired training output signal (tᵢ) and the ascertained training output signal (yᵢ) are transmitted to a change unit (180).

On the basis of the desired training output signal (tᵢ) and the ascertained output signal (yᵢ), new parameters (Φ′) for the machine learning system (60) are then determined by the change unit (180). For this purpose, the change unit (180) compares the desired training output signal (tᵢ) and the ascertained training output signal (yᵢ) by means of a loss function. The loss function ascertains a first loss value that characterizes how far the ascertained training output signal (yᵢ) deviates from the desired training output signal (tₗᵢ). In the exemplary embodiment, a negative log-likehood function is selected as the loss function. In alternative exemplary embodiments, other loss functions are also possible.

The change unit (180) ascertains the new parameters (Φ′) on the basis of the first loss value. In the exemplary embodiment, this is done by means of a gradient descent method, preferably stochastic gradient descent, Adam, or AdamW.

The ascertained new parameters (Φ′) are stored in a model parameter memory (St₁). The ascertained new parameters (Φ′) are preferably provided as parameters (Φ) to the classifier (60).

In further preferred exemplary embodiments, the described training is iteratively repeated for a predefined number of iteration steps or is iteratively repeated until the first loss value falls below a predefined threshold. Alternatively, or additionally, it is also possible that the training is terminated if an average first loss value with respect to a test or validation data set falls below a predefined threshold value. In at least one of the iterations, the new parameters (Φ′) determined in a previous iteration are used as parameters (Φ) of the classifier (60).

Furthermore, the training system (140) may comprise at least one processor (145) and at least one machine-readable storage medium (146) containing instructions that, when executed by the processor (145), cause the training system (140) to carry out a training method according to one of the aspects of the present invention.

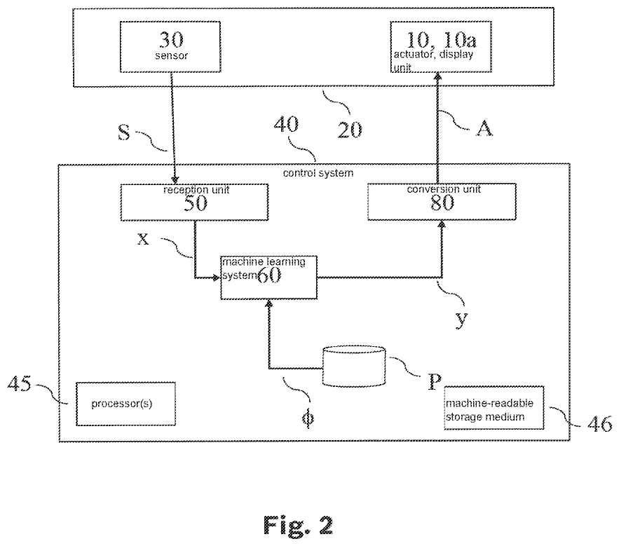

FIG. 2 shows a control system (40) controlling an actuator (10) of a technical system by means of a machine learning system (60), wherein the machine learning system (60) has been trained by means of the training device (140). At preferably regular intervals, a second operating variable or a second operating state is sensed using a sensor (30). The sensed input signal (S) of the sensor (30) is transmitted to the control system (40). The control system (40) thus receives a succession of input signals (S). Therefrom, the control system (40) ascertains control signals (A), which are transmitted to the actuator (10).

The control system (40) receives the succession of input signals (S) of the sensor (30) in a reception unit (50) that converts the succession of input signals (S) into a time series (x). This may take place, for example, via a series of a predefined number of recently received input signals (S). In other words, the time series (x) is ascertained depending on the input signals (S). The succession of input signals (x) is supplied to the machine learning system (60).

The machine learning system (60) ascertains an output signal (y) from the time series (x). Output signals (y) are supplied to an optional conversion unit (80), which therefrom ascertains control signals (A), which are supplied to the actuator (10) in order to control the actuator (10) accordingly.

The actuator (10) receives the control signals (A), is controlled accordingly, and carries out a corresponding action.

The actuator (10) can comprise a (not necessarily structurally integrated) control logic which, from the control signal (A), ascertains a second control signal which is then used to control the actuator (10).

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) in which instructions are stored that, when executed on the at least one processor (45), cause the control system (40) to carry out the method according to the present invention.

In alternative embodiments, as an alternative or in addition to the actuator (10), a display unit (10a) is provided.

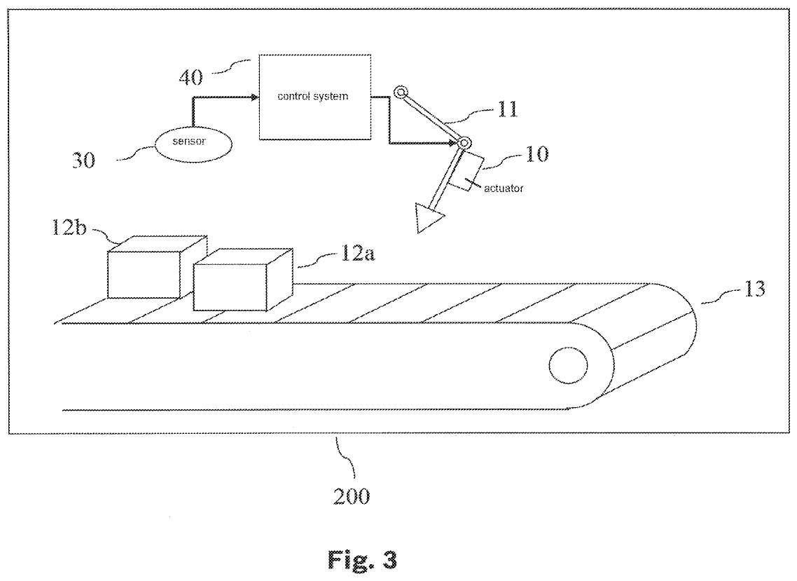

FIG. 3 shows an exemplary embodiment in which the control system (40) is used to control a production machine (11) of a production system (200) by controlling an actuator (10) controlling the production machine (11). For example, the production machine (11) may be a machine for welding.

The sensor (30) may preferably be a sensor (30) that ascertains a voltage of the welding device of the production machine (11). The machine learning system (60) can in particular be trained to classify, on the basis of a time series (x) of voltages, whether or not the welding operation was successful. The actuator (10) can automatically reject a corresponding part if the welding operation is unsuccessful.

In an alternative exemplary embodiment, it is also possible for the production machine (11) to join two parts by means of a pressure. In this case, the sensor (30) can be a pressure sensor and the machine learning system (60) can ascertain whether or not the joint was correct.

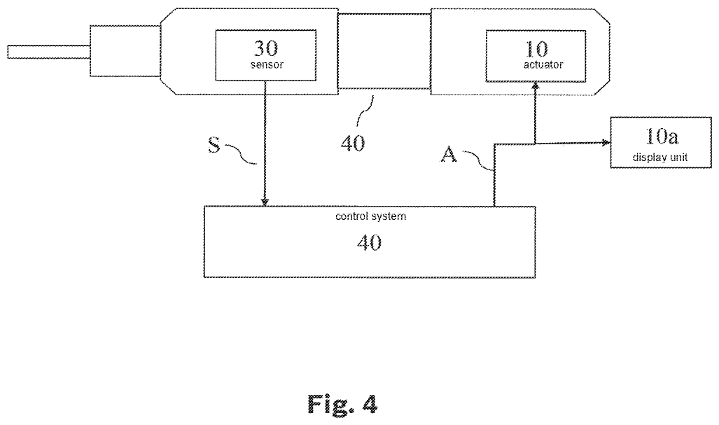

FIG. 4 shows an exemplary embodiment for controlling an injector (40) of an internal combustion engine. In the exemplary embodiment, the sensor (30) is a pressure sensor that ascertains a pressure of an injection system (10) that supplies the injector (40) with fuel. In particular, the machine learning system (60) can be designed to accurately ascertain, on the basis of the time series (x) of pressure values, an injection amount of the fuel.

On the basis of the ascertained injection amount, the actuator (10) can then be controlled in future injection operations such that too large an amount of injected fuel or too little an amount of injected fuel is compensated appropriately.

In alternative embodiments, as an alternative or in addition to the control unit (40), it is provided that at least one further device (10a) is controlled by means of the control signal (A). For example, the device (10a) may be a pump of a common rail system to which the injector (20) belongs. Alternatively or additionally, it is possible that the device is a control device of the internal combustion engine. Alternatively or additionally, it is also possible that the device (10a) is a display unit by means of which the amount of fuel ascertained by the machine learning system (60) can be displayed appropriately to a person (e.g., a driver or a mechanic).

The term “computer” includes any device for processing specifiable calculation rules. These calculation rules can be provided in the form of software or in the form of hardware or else in a mixed form of software and hardware.

A plurality can be generally be understood as being indexed, i.e., each element of the plurality is assigned a unique index, preferably by assigning consecutive integers to the elements contained in the plurality. If a plurality comprises N elements, wherein N is the number of elements in the plurality, the elements are preferably assigned whole numbers from 1 to N.

1-31. (canceled)

32. A method for a computer-implemented machine learning system, the machine learning system being configured to ascertain an output signal based on a time series of input signals of a technical system, the output signal characterizing a classification and/or a regression result of at least one first operating state and/or at least one first operating variable of the technical system, the method comprising the following steps:
training the machine learning system, including:
a. ascertaining a first training time series of input signals from a plurality of training time series and a desired training output signal which corresponds to the first training time series, the desired training output signal characterizing a desired classification and/or a desired regression result of the first training time series;
b. ascertaining a worst possible training time series, the worst possible training time series characterizing an overlap of the first training time series with an ascertained first noise signal;
c. ascertaining a training output signal based on the worst possible training time series using the machine learning system; and
d. adapting at least one parameter of the machine learning system according to a gradient of a loss value, wherein the loss value characterizes a deviation of the desired output signal from the ascertained training output signal.

33. The method according to claim 32, wherein, in step b., the first noise signal is ascertained by optimization such that a distance of a second output signal from the desired output signal is enlarged, wherein the second output signal is ascertained by the machine learning system based on the overlap of the first training time series with the first noise signal.

34. The method according to claim 32, wherein the first noise signal is ascertained in step b. based on an expected noise value of the plurality of training time series, wherein the expected noise value characterizes an average intensity of noise of the training time series.

35. The method according to claim 34, wherein the expected noise value is an average distance of each training time series of the plurality of training time series from a respective, denoised training time series.

36. The method according to claim 35, wherein the expected noise value is ascertained according to the formula
$$Δ = \frac{1}{n} {\sum }_{i = 1}^{n} {‖ {x}_{i} - {z}_{i} ‖}_{2} ,$$
wherein n is a number of training time series of the plurality of training time series, zᵢ is the denoised training time series for the training time series xᵢ, and ∥⋅∥₂ is a Euclidean norm.

37. The method according to claim 36, wherein the denoised training time series is ascertained according to the formula
zᵢ=Cₖ⁺·xᵢ,
wherein Cₖ⁺ is a pseudo-inverse covariance matrix.

38. The method according to claim 37, wherein the pseudo-inverse covariance matrix is ascertained by the following steps:
e. ascertaining a second covariance matrix, wherein the second covariance matrix is the covariance matrix of the plurality of training time series;
f. ascertaining a predefined plurality of greatest eigenvalues of the second covariance matrix and eigenvectors corresponding to the eigenvalues;
g. ascertaining the pseudo-inverse covariance matrix according to the formula
$${C}_{k}^{+} = {\sum }_{i = 1}^{k} \frac{1}{{λ}_{i}} \cdot {v}_{i} {v}_{i}^{T} ,$$
wherein λᵢ is the i-th eigenvalue of the plurality of greatest eigenvalues, and k is the number of greatest eigenvalues in the predefined plurality of greatest eigenvalues.

39. The method according to claim 34, wherein the first noise signal is ascertained based on a provided adversarial perturbation, wherein the provided adversarial perturbation is limited according to the expected noise value.

40. The method according to claim 39, wherein the adversarial perturbation is limited such that a noise value of the adversarial perturbation is not greater than the expected noise value.

41. The method according to claim 40, wherein the noise value of the adversarial perturbation is ascertained according to the formula
r(δ,Cₖ⁺)=∥δ−Cₖ⁺·δ∥₂,
wherein δ is the adversarial perturbation.

42. The method according to claim 39, wherein the adversarial perturbation is provided according to the following steps:
h. providing a first adversarial perturbation;
i. ascertaining a second adversarial perturbation, wherein with respect to the first training time series, the second adversarial perturbation being stronger than the first adversarial perturbation;
j. providing the second adversarial perturbation as the adversarial perturbation when a distance of the second adversarial perturbation from the first adversarial perturbation is less than or equal to a predefined threshold;
k. otherwise, when the noise value of the second adversarial perturbation is less than or equal to an expected noise value, performing step i., wherein, in the performance of step i., the second adversarial perturbation is used as the first adversarial perturbation;
l. otherwise, ascertaining a projected perturbation and performing step j., wherein, in the performance of step j., the projected perturbation is used as the second adversarial perturbation, and wherein the projected perturbation is ascertained by an optimization such that a distance of the projected perturbation from the second adversarial perturbation is as small as possible and the noise value of the projected perturbation is equal to the expected noise value.

43. The method according to claim 42, wherein the first adversarial perturbation is randomly ascertained in step h.

44. The method according to claim 42, wherein, in step h., the first adversarial perturbation contains at least one predefined value.

45. The method according to claim 42, wherein, in step i., the second adversarial perturbation is ascertained according to the formula
δ₂=δ₁+α−Cₖ·g,
wherein δ₁ is the first adversarial perturbation, a is a predefined step-width value, Cₖ is a first covariance matrix, and g is a gradient.

46. The method according to claim 45, wherein the gradient g is ascertained according to the formula
g=∇ₓ_{ᵢ}[L(f(xᵢ±δ₁),tᵢ)],
wherein L is a loss function, tᵢ is the desired training output signal with respect to the first training time series (xᵢ), and f(xᵢ+δ₁) is the result of the machine learning system when the first training time series (xᵢ) overlapped with the first adversarial perturbation δ₁ is passed to the machine learning system.

47. The method according to claim 45, wherein the first covariance matrix is ascertained according to the formula
$${C}_{k} = {\sum }_{i = 1}^{k} {λ}_{i} \cdot {v}_{i} {v}_{i}^{T} .$$

48. The method according to claim 42, wherein, in step l., the projected adversarial perturbation is ascertained according to the formula
$${δ}_{p} = {argmin}_{d , r ( d , {C}_{k}^{+} ) = Δ} {‖ d - {δ}_{2} ‖}_{2} .$$

49. The method according to claim 32, wherein each input signal respectively characterizes a temperature and/or a pressure and/or a voltage and/or a force and/or a speed and/or a rotation rate and/or a torque of the technical system.

50. The method according to claim 49, wherein the input signals are each recorded with at least one sensor.

51. The method according to claim 32, wherein the input signals of the time series respectively characterize a second operating state and/or a second operating variable of the technical system at a predefined time point, and the input signals of the first training time series respectively characterize a second operating state and/or a second operating variable of the technical system or of a structurally identical technical system or of a structurally similar technical system or a simulation of the second operating state and/or of the second operating variable at a predefined time point.

52. The method according to claim 32, wherein the output signal characterizes a regression of at least the first operating state and/or at least the first operating variable of the technical system, wherein the loss value characterizes a squared Euclidean distance between the ascertained training output and the desired training output.

53. The method according to claim 52, wherein the technical system is an injection device of an internal combustion engine and the input signals of the time series each characterize at least one pressure value or an average pressure value of the injection device, and the output signal characterizes an injection amount of a fuel, wherein the input signals of the training time series each furthermore characterize at least one pressure value or an average pressure value of the internal combustion engine or of a structurally identical internal combustion engine or of a structurally similar internal combustion engine or of a simulation of the internal combustion engine, and the desired training output signal characterizes an injection amount of the fuel.

54. The method according to claim 32, wherein the technical system is a production machine, which produces at least one part, wherein the input signals of the time series each characterize a force and/or a torque of the production machine, and the output signal characterizes a classification as to whether or not the part was produced correctly, wherein the input signals of the training time series each furthermore characterize a force and/or a torque of the production machine or of a structurally identical production machine or of a structurally similar production machine or of a simulation of the production machine, and the desired training output signal is a classification as to whether a part was produced correctly.

55. The method according to claim 32, wherein the machine learning system ascertains the output signal using a neural network.

56. The method according to claim 55, wherein the neural network is a recurrent neural network (RNN).

57. The method according to claim 55, wherein the machine learning system is a convolutional neural network (CNN).

58. The method according to claim 55, wherein the neural network is a transformer.

59. The method according to claim 55, wherein the neural network is a multilayer perceptron (MVLP).

60. A training device configured to train a machine learning system the machine learning system being configured to ascertain an output signal based on a time series of input signals of a technical system, the output signal characterizing a classification and/or a regression result of at least one first operating state and/or at least one first operating variable of the technical system, the training device configured to:
a. ascertain a first training time series of input signals from a plurality of training time series and a desired training output signal which corresponds to the first training time series, the desired training output signal characterizing a desired classification and/or a desired regression result of the first training time series;
b. ascertain a worst possible training time series, the worst possible training time series characterizing an overlap of the first training time series with an ascertained first noise signal;
c. ascertain a training output signal based on the worst possible training time series using the machine learning system; and
d. adapt at least one parameter of the machine learning system according to a gradient of a loss value, wherein the loss value characterizes a deviation of the desired output signal from the ascertained training output signal.

61. A non-transitory machine-readable storage medium on which is stored a computer program for training a computer-implemented machine learning system, the machine learning system being configured to ascertain an output signal based on a time series of input signals of a technical system, the output signal characterizing a classification and/or a regression result of at least one first operating state and/or at least one first operating variable of the technical system, the computer program, when executed by a processor, causing the processor to perform:
training the machine learning system, including:
a. ascertaining a first training time series of input signals from a plurality of training time series and a desired training output signal which corresponds to the first training time series, the desired training output signal characterizing a desired classification and/or a desired regression result of the first training time series;
b. ascertaining a worst possible training time series, the worst possible training time series characterizing an overlap of the first training time series with an ascertained first noise signal;
c. ascertaining a training output signal based on the worst possible training time series using the machine learning system; and
d. adapting at least one parameter of the machine learning system according to a gradient of a loss value, wherein the loss value characterizes a deviation of the desired output signal from the ascertained training output signal.
